(19) United States
(12) Patent Application Publication
(10) Pub. No.: US 2026/0200095 A1
(43) Pub. Date: Jul. 16, 2026

(54) ROBOT

(71) Applicant: AISAN KOGYO KABUSHIKI KAISHA, Obu-shi (JP)

(72) Inventors: Taisuke KAGAU, Kariya-shi (JP); Yuichiro IMAI, Tokai-shi (JP)

(21) Appl. No.: 19/434,406

(22) Filed: Dec. 29, 2025

(30) Foreign Application Priority Data
Jan. 14, 2025 (JP) 2025-005056

(51) Int. Cl. B25J 9/16

(52) U.S. Cl. CPC B25J 9/1697

(57) ABSTRACT

The controller may be configured to: operate the movable arm to move the gripper and the imaging unit to a position near the workpiece, recognize a position and an appearance of the workpiece based on first image information obtained by imaging the workpiece by the imaging unit, grip the recognized workpiece by the gripper, operate the movable arm, with the gripper gripping the workpiece, to move the gripper and the imaging unit to a position near the landmark attached on the placement section, recognize a position of the placement section based on second image information obtained by imaging the landmark by the imaging unit, and place the workpiece gripped by the gripper on the recognized placement section.

### CROSS REFERENCE TO RELATED APPLICATION(S)

This application claims priority from Japanese Patent Application No. 2025-005056 filed on January 14, 2025. The entire content of the priority application is incorporated herein by reference.

### TECHNICAL FIELD

The art disclosed herein relates to a robot.

### BACKGROUND ART

Patent Literature 1 (Japanese Patent Application Publication No. 2022-82274) describes a robot configured to place a workpiece on a placement section marked with a landmark. The robot of Patent Literature 1 includes a movable arm and a controller configured to control the movable arm. The movable arm includes a gripper configured to grip the workpiece and an imaging unit configured to image the landmark marked in the placement section. The robot of Patent Literature 1 places the workpiece on the placement section in accordance with the landmark read by the imaging unit.

The robot of Patent Literature 1 may sometimes fail to properly grip the workpiece because the robot grips the workpiece without recognizing the appearance of the workpiece when gripping the workpiece with the gripper of the movable arm. As a result of this, the workpiece may not be placed at a proper position when placing the workpiece on the placement section marked with the landmark. The present teachings provide an art that allows to place a workpiece at a proper position.

### SUMMARY

A robot configured to place a workpiece on a placement section marked with a landmark is disclosed herein, and the robot may comprise: a movable arm; and a controller configured to control the movable arm, wherein the movable arm may comprise a gripper configured to grip the workpiece and an imaging unit configured to image the landmark attached on the placement section and the workpiece, and the controller may be configured to: operate the movable arm to move the gripper and the imaging unit to a position near the workpiece, recognize a position and an appearance of the workpiece based on first image information obtained by imaging the workpiece by the imaging unit, grip the recognized workpiece by the gripper, operate the movable arm, with the gripper gripping the workpiece, to move the gripper and the imaging unit to a position near the landmark attached on the placement section, recognize a position of the placement section based on second image information obtained by imaging the landmark by the imaging unit, and place the workpiece gripped by the gripper on the recognized placement section.

### BRIEF DESCRIPTION OF DRAWINGS

FIG. 1 illustrates a perspective view of a robot system according to an embodiment.

FIG. 2 illustrates a top view of the robot system according to the embodiment.

FIG. 3 illustrates a flow chart of a control process executed in the robot system according to the embodiment.

### DETAILED DESCRIPTION

In one aspect of the present teachings, a robot may be configured to place a workpiece on a placement section marked with a landmark, and the robot may comprise: a movable arm; and a controller configured to control the movable arm, wherein the movable arm may comprise a gripper configured to grip the workpiece and an imaging unit configured to image the landmark attached on the placement section and the workpiece, and the controller may be configured to: operate the movable arm to move the gripper and the imaging unit to a position near the workpiece, recognize a position and an appearance of the workpiece based on first image information obtained by imaging the workpiece by the imaging unit, grip the recognized workpiece by the gripper, operate the movable arm, with the gripper gripping the workpiece, to move the gripper and the imaging unit to a position near the landmark attached on the placement section, recognize a position of the placement section based on second image information obtained by imaging the landmark by the imaging unit, and place the workpiece gripped by the gripper on the recognized placement section.

According to this configuration, when the workpiece is gripped by the gripper of the movable arm, the workpiece is gripped with the position and the appearance of the workpiece recognized. Thus, the workpiece can be properly gripped. As a result of this, the workpiece can be placed at a proper position when the workpiece is placed on the placement section marked with the landmark.

In one embodiment of the present teachings, the placement section marked with the landmark may be configured movable.

Even when the placement section is moved, according to the above configuration, by recognizing the position of the placement section based on the second image information, the workpiece can be properly placed on the placement section.

In one embodiment of the present teachings, the robot may be configured to operate on power generated by a solar power generation device.

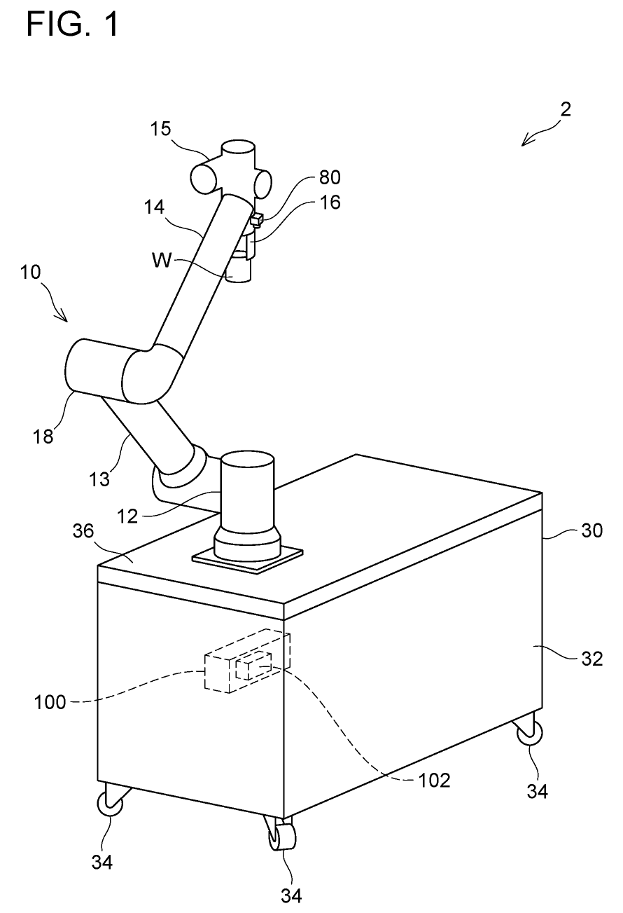

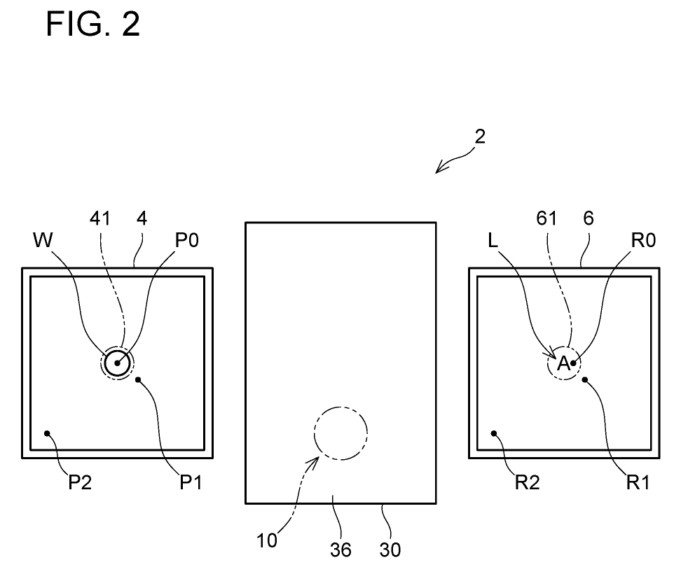

A robot system 2 of an embodiment will be described with reference to drawings. As illustrated in FIG. 1, the robot system 2 of the embodiment comprises a movable platform 30, and a work robot 10 mounted on the movable platform 30. As illustrated in FIG. 2, the robot system 2 comprises a first box 4 and a second box 6 that are disposed at positions apart from the movable platform 30.

As illustrated in FIG. 1, the movable platform 30 comprises a body 32 and a plurality of wheels 34 attached to the body 32. The movable platform 30 is configured movable in multiple directions by having the plurality of wheels 34. The plurality of wheels 34 is attached below the body 32. The movable platform 30 can move in multiple directions on a floor, for example. In a modification, the movable platform 30 may be configured to move on and along rail(s). The movable platform 30 is configured to move manually or automatically.

The body 32 of the movable platform 30 is configured in a box shape, for example. The body 32 comprises a top surface part 36 on which the work robot 10 is placed. The body 32 supports the work robot 10. The body 32 is constituted of, for example, aluminum alloy.

The work robot 10 is secured on the top surface part 36 of the movable platform 30. The installing position of the work robot 10 on the top surface part 36 of the movable platform 30 may be determined according to necessities. The work robot 10 is an articulated robot comprising a movable arm 18, for example. The work robot 10 can grip a workpiece W to be worked on. Further, the work robot 10 can move the workpiece W while gripping the workpiece W. For example, the work robot 10 can grip the workpiece W housed in the first box 4 and move the same to the second box 6.

How the work robot 10 is configured is not particularly limited. The work robot 10 comprises, for example, a base end 12, the movable arm 18, and a controller 100.

The base end 12 of the work robot 10 is secured on the top surface part 36 of the movable platform 30. The movable arm 18 of the work robot 10 comprises a first part 13, a second part 14, a distal end 15, and a gripper 16. Further, the movable arm 18 comprises an imaging unit 80 (e.g., camera).

The first part 13 of the movable arm 18 is coupled to the base end 12. The first part 13 is configured to pivot relative to the base end 12. The first part 13 is configured to pivot about, for example, one or more axes. The second part 14 is coupled to the first part 13. The second part 14 is configured to pivot relative to the first part 13. The second part 14 is configured to pivot about, for example, one or more axes. The distal end 15 is coupled to the second part 14. The distal end 15 is configured to pivot relative to the second part 14. The distal end 15 is configured to pivot about, for example, one or more axes.

The gripper 16 of the movable arm 18 is coupled to the distal end 15 of the movable arm 18. The gripper 16 is configured to grip the workpiece W to be worked on. The gripper 16 includes, for example, a plurality of claw members and grips the workpiece W by bringing the claw members together or apart. The gripper 16 may be called "chuck."

The imaging unit 80 is attached to the distal end 15 of the movable arm 18. In a modification, the imaging unit 80 may be attached to the gripper 16 of the movable arm 18. The imaging unit 80 is configured to image the workpiece W housed in the first box 4. The imaging unit 80 obtains image information of appearance of the workpiece W by imaging the workpiece W.

The imaging unit 80 is configured to image a landmark L marked in a second placement section 61 (see FIG. 2) of the second box 6. The imaging unit 80 obtains image information of the landmark L by imaging the landmark L marked in the second placement section 61.

The first box 4 comprises a first placement section 41. The workpiece W is placed on the first placement section 41. The first placement section 41 is a place where the workpiece W to be gripped by the gripper 16 is placed. In the present embodiment, the first box 4 comprises one first placement section 41.

The second box 6 comprises the second placement section 61. The second placement section 61 is a place where the workpiece W gripped by the gripper 16 is to be placed. In the present embodiment, the second box 6 comprises one second placement section 61. The second placement section 61 of the second box 6 is marked with the landmark L.

The landmark L is a mark which is identification information of the second placement section 61. The landmark L marked in the second placement section 61 has for example orientation information and shape information. For example, the landmark L shown in FIG. 2 has information that, in the up-down direction of the drawing, the upward is a positive orientation and the downward is a negative orientation. Further, the landmark L shown in FIG. 2 has information that, in the left-right direction of the drawing, the left is a positive orientation and the right is a negative orientation. The landmark L shown in FIG. 2 has information of the shape shown in FIG. 2 (for example, shape like "A" in alphabet).

The second box 6 housing the workpiece W may be movable or immovable. For example, the second box 6 may be configured such that the second box 6 is placed on a different movable platform (not shown) different from the movable platform 30 and is configured to move by that movable platform moving. Also, the second box 6 may be configured portable by an operator, and be configured to move by the operator carrying the second box 6. The second placement section 61 moves along when the second box 6 moves.

Also, the second box 6 may be secured on a fixed platform (not shown) so that it does not move, for example. In this case, the second placement section 61 and the landmark L do not move, either. Here, the position where the second placement section 61 is disposed is not limited in particular. For example, the second placement section 61 may be disposed on the top surface part 36 of the movable platform 30. Also, the second placement section 61 may be disposed on a ground.

The controller 100 comprises, for example a CPU, and executes various controls and/or processes regarding the robot system 2 based on a predetermined program. The controller 100 comprises a memory 102 which stores predetermined program(s), for example.

The memory 102 comprises for example a ROM and RAM, and stores various information regarding the robot system 2. For example, the memory 102 stores information for moving the workpiece W placed on the first placement section 41 to the second placement section 61 marked with the landmark L to be placed on the second placement section 61. For example, the memory 102 has first position information, first reference image information, second position information, and second reference image information prestored therein.

The first position information is information indicating the position of the workpiece W to be gripped by the gripper 16. The first position information is information indicating the position of the first placement section 41 on which the workpiece W is placed. If the number of the workpiece W to be gripped by the gripper 16 is one, the memory 102 has the first position information regarding that one workpiece W stored therein. If the number of the workpiece W to be gripped by the gripper 16 is plural, the memory 102 has the first position information regarding each of those plural workpieces W stored therein.

The first reference image information includes appearance information indicating the appearance of the workpiece W to be gripped by the gripper 16. The first reference image information includes, for example, shape information indicating the shape of the workpiece W and posture information indicating the posture of the workpiece W. If the number of the workpiece W to be gripped by the gripper 16 is one, the memory 102 has the first reference image information regarding that one workpiece W stored therein. The number of the workpiece W to be gripped by the gripper 16 is plural, the memory 102 has the first reference image information regarding those plural workpieces W stored therein.

The second position information is information indicating the position of the second placement section 61 where the workpiece W gripped by the gripper 16 is to be placed. If the number of the workpiece W to be gripped by the gripper 16 is one, the memory 102 has the second position information regarding the second placement section 61 which is the place on which that one workpiece W is to be placed, stored therein. If the number of the workpiece W to be gripped by the gripper 16 is plural, the memory 102 has the second position information regarding a plurality of the second placement sections 61 that are places on which those respective plural workpieces W are to be placed, stored therein.

The second reference image information includes the appearance information indicating the appearance of the landmark L marked in the second placement section 61 on which the workpiece W is to be placed. The second reference image information includes, for example, shape information indicating the shape of the landmark L and orientation information indicating the orientation of the landmark L. If the number of the workpiece W to be gripped by the gripper 16 is one, the memory 102 has the second reference image information regarding the landmark L marked in the second placement section 61 which is the place on which that one workpiece W is to be placed, stored therein. If the number of the workpiece W to be gripped by the gripper 16 is plural, the memory 102 has a plurality of pieces of the second reference image information regarding a plurality of the landmarks L marked in a plurality of the second placement sections 61 that are places on which the respective plural workpieces W are to be placed, stored therein.

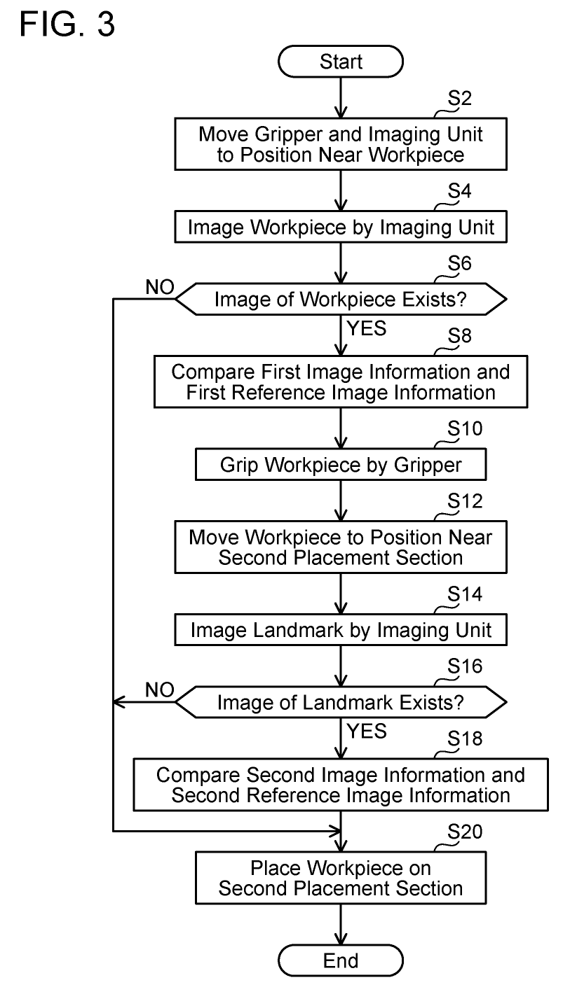

Next, a control process executed by the robot system 2 of the embodiment will be described. FIG. 3 is a flowchart of the control process executed in the robot system 2. The control process shown in FIG. 3 is started, for example, upon a predetermined start instruction being inputted to the controller 100. In the present embodiment, the control process for one workpiece W will be described.

At a timing when the control process shown in FIG. 3 is started, the workpiece W is placed on the first placement section 41 of the first box 4. This workpiece W is placed at a position indicated by the first position information (for example, position PO shown in FIG. 2) stored in the memory 102. However, the actual workpiece W may be precisely placed at the position PO indicated by the first position information, or may not be placed precisely at the position PO indicated by the first position information.

The situation where the workpiece W is not placed precisely at the position PO indicated by the first position information can be considered to include a situation where, for example, the workpiece W is placed at a position slightly offset from the position PO indicated by the first position information (for example, a position P1 shown in FIG. 2). Also, the situation where the workpiece W is not placed precisely at the position PO indicated by the first position information can be considered to include a situation where, for example, the workpiece W is placed at a position greatly offset from the position PO indicated by the first position information (for example, position P2 shown in FIG. 2).

As illustrated in FIG. 3, in S2 of the control process, the controller 100 operates the movable arm 18 to move the gripper 16 of the movable arm 18 and the imaging unit 80 to a position near the workpiece W housed in the first box 4. Here, the controller 100 moves the gripper 16 and the imaging unit 80 to the position near the workpiece W based on the first position information stored in the memory 102. The first position information is information indicating the position of the workpiece W to be gripped by the gripper 16.

As mentioned above, there may be cases where the actual workpiece W is placed precisely at the position PO indicated by the first position information, and also cases where the actual workpiece W is not placed precisely at the position PO indicated by the first position information.

In S4 following S2, the controller 100 images the workpiece W housed in the first box 4 by using the imaging unit 80. Due to this, the controller 100 obtains first image information regarding the workpiece W. The first image information includes image information of the appearance of the workpiece W.

In S4, even when the actual workpiece W is not placed precisely at the position PO indicated by the first position information, if the workpiece W exists in a range imaged by the imaging unit 80, the image obtained by the imaging unit 80 includes the image of the appearance of the workpiece W. For example, when the actual workpiece W is placed at the position P1 slightly offset from the position PO indicated by the first position information, the workpiece W exists in the range imaged by the imaging unit 80, and the image obtained by the imaging unit 80 includes the image of the appearance of the workpiece W.

Contrary to this, if the workpiece W does not exist in the range imaged by the imaging unit 80, the image obtained by the imaging unit 80 does not include the image of the appearance of the workpiece W. For example, if the actual workpiece W is placed at the position P2 greatly offset from the position PO indicated by the first position information, the workpiece W does not exist in the range imaged by the imaging unit 80, and thus the image obtained by the imaging unit 80 does not include the image of the appearance of the workpiece W. In this case, the image information of the appearance of the workpiece W is not included in the first image information.

In S6 following S4, the controller 100 determines whether the first image information obtained in the above-mentioned S4 includes the image information of the appearance of the workpiece W or not. If the first image information includes the image information of the appearance of the workpiece W (YES to S6), the process proceeds to S8. In this case, the workpiece W exists in the range imaged by the imaging unit 80. For example, the workpiece W is placed at the position PO indicated by the first position information, or the workpiece W is placed at the position P1 slightly offset from the position PO indicated by the first position information.

Contrary to this, if the first image information does not include the image information of the appearance of the workpiece W (NO to S6), the controller 100 ends the control process of FIG. 3. In this case, the workpiece W does not exist in the range imaged by the imaging unit 80. For example, the workpiece W is placed at the position P2 greatly offset from the position PO indicated by the first position information. Here, in case of NO to S6, the controller 100 may notify predetermined error information using a notifier (not shown).

In S8 after YES to S6, the controller 100 compares the first image information obtained in the above-mentioned S4 with the first reference image information stored in the memory 102. The first image information and the first reference image information both include the image information of the appearance of the workpiece W. The controller 100 recognizes the position and appearance of the actual workpiece W by comparing the first image information and the first reference image information with each other. For example, the controller 100 recognizes the position and appearance of the actual workpiece W by calculating a difference between the first image information and the first reference image information. Due to this, even when the actual workpiece W is not placed precisely at the position PO indicated by the first position information, the position and appearance of the actual workpiece W can be recognized.

In the subsequent S10, the controller 100 grips the actual workpiece W (i.e., the workpiece W imaged by the imaging unit 80) by using the gripper 16. The controller 100 may grip the workpiece W by using the gripper 16 in accordance with the appearance of the workpiece W. For example, the controller 100 may grip the workpiece W by using the gripper 16 with the orientation of the workpiece W and the orientation of the gripper 16 aligned with each other. The controller 100 grips the workpiece W by suitably moving each component 13, 14, 15, 16 of the movable arm 18.

In the subsequent S12, the controller 100 operates the movable arm 18, with the gripper 16 gripping the workpiece W, to move the workpiece W gripped by the gripper 16 to a position near the second placement section 61. Here, the controller 100 moves the workpiece W to the position near the second placement section 61 based on the second position information stored in the memory 102. The second position information is information indicating the position of the second placement section 61 on which the workpiece W is to be placed.

Here, the actual second placement section 61 may exist at a position indicated by the second position information (for example, position RO shown in FIG. 2), or may not exist at the position RO shown by the second position information. For example, due to the second box 6 having been moved, the actual second placement section 61 may become offset from the position RO indicated by the second position information.

The situation where the second placement section 61 does not exist at the position RO indicated by the second position information can be considered to include a situation where, for example, the second placement section 61 exists at a position slightly offset from the position RO indicated by the second position information (for example, position R1 shown in FIG. 2). Also, the situation where the second placement section 61 does not exist at the position RO indicated by the second position information can be considered to include a situation where, for example, the second placement section 61 exists at a position greatly offset from the position RO indicated by the second position information (for example, position R2 shown in FIG. 2).

As illustrated in FIG. 3, in S14 following S12, the controller 100 images the landmark L marked in the second placement section 61 by using the imaging unit 80. Due to this, the controller 100 obtains second image information regarding the landmark L marked in the second placement section 61. The second image information includes image information of the landmark L marked in the second placement section 61.

In S14, even when the actual second placement section 61 does not exist at the position RO indicated by the second position information, if the second placement section 61 and the landmark L exist in the range imaged by the imaging unit 80, the image obtained by the imaging unit 80 includes the image of the landmark L. For example, when the actual second placement section 61 exists at the position R1 slightly offset from the position RO indicated by the second position information, the actual second placement section 61 and the landmark L exist in the range imaged by the imaging unit 80, and thus the image obtained by the imaging unit 80 includes the image of the landmark L.

Contrary to this, when the second placement section 61 and the landmark L do not exist in the range imaged by the imaging unit 80, the image obtained by the imaging unit 80 does not include the image of the landmark L. For example, if the actual second placement section 61 exists at the position R2 that is greatly offset from the position RO indicated by the second position information, the second placement section 61 and the landmark L do not exist in the range imaged by the imaging unit 80, and thus the image obtained by the imaging unit 80 does not include the image of the landmark L. In this case, the second image information does not include the image information of the landmark L.

In the following S16, the controller 100 determines whether the second image information obtained in the above-mentioned S14 includes the image information of the landmark L or not. If the second image information includes the image information of the landmark L (YES to S16), the process proceeds to S18. In this case, the second placement section 61 and the landmark L exist in the range imaged by the imaging unit 80. For example, the second placement section 61 and the landmark L exist at the position RO indicated by the second position information or the second placement section 61 and the landmark L exist at the position R1 slightly offset from the position RO indicated by the second position information.

Contrary to this, the second image information does not include the image information of the landmark L (NO to S16), the controller 100 ends the control process of FIG. 3. In this case, the second placement section 61 and the landmark L do not exist in the range imaged by the imaging unit 80. For example, the second placement section 61 and the landmark L exist at the position R2 greatly offset from the position RO indicated by the second position information. Here, in case of NO to S16, the controller 100 may notify predetermined error information using a notifier (not shown).

In S18 after YES to S16, the controller 100 compares the second image information obtained in the above-mentioned S14 with the second reference image information stored in the memory 102. The second image information and the second reference image information both include the image information of the landmark L. The controller 100 recognizes the position of the actual second placement section 61 by comparing the second image information and the second reference image information with each other. For example, the controller 100 recognizes the position of the actual second placement section 61 by calculating the difference between the second image information and the second reference image information. The controller 100 also recognizes the appearance of the landmark L marked in the actual second placement section 61 by comparing the second image information and the second reference image information with each other. Due to this, even when the actual second placement section 61 does not exist at the position RO indicated by the second position information, the actual second placement section 61 and the landmark L can be recognized.

In the subsequent S20, the controller 100 places the workpiece W gripped by the gripper 16 on the actual second placement section 61. The controller 100 may place the workpiece W gripped by the gripper 16 in accordance with the orientation of the landmark L. For example, the controller 100 may place the workpiece W on the second placement section 61, with the orientation of the landmark L and the orientation of the workpiece W aligned with each other. The controller 100 places the workpiece W on the second placement section 61, by suitably moving each component 13, 14,15, 16 of the movable arm 18.

(Effects) As above, the robot system 2 of the embodiment has been described. As is obvious from the above description, in the robot system 2 of the embodiment, the controller 100 is configured to: operate the movable arm 18 to move the gripper 16 and the imaging unit 80 to a position near the workpiece W, recognize the position and the appearance of the workpiece W based on the first image information obtained by imaging the workpiece W by the imaging unit 80, and grip the recognized workpiece W by the gripper 16 (S4-S10 in FIG. 3). Further, the controller 100 is configured to operate the movable arm 18, with the gripper 16 gripping the workpiece W, to move the workpiece W, the gripper 16, and the imaging unit 80 to a position near the landmark L marked in the second placement section 61, recognize the position of the second placement section 61 based on the second image information obtained by imaging the landmark L by the imaging unit 80, and place the workpiece W gripped by the gripper 16 on the recognized second placement section 61 (S12-S20 of FIG. 3).

According to this configuration, when the workpiece W is gripped by the gripper 16 of the movable arm 18, the workpiece W is gripped with the position and the appearance of the workpiece W recognized. Thus, the workpiece W can be properly gripped. As a result of this, the workpiece W can be placed at a proper position when the workpiece W is placed on the second placement section 61 marked with the landmark L.

In the robot system 2 of the embodiment, the second placement section 61 marked with the landmark L is configured movable. For example, the second box 6 comprising the second placement section 61 is configured portable. Even when the second placement section 61 is moved, according to the above configuration, by recognizing the position of the second placement section 61 based on the second image information, the workpiece W can be properly placed on the second placement section 61.

(Modifications) Although in the above embodiment the control process for one workpiece W has been described, the control process of FIG. 3 can be applied to plural workpieces W. In this case, the controller 100 repeats the control process of FIG. 3 plural times. Due to this, the plural workpieces W can be moved from the first placement sections 41 to the second placement sections 61 and be placed on the second placement sections 61.

A robot system 2 in a modification may comprise a solar power generation device (not shown) that generates electric power using sunlight. The work robot 10 in the robot system 2 may be configured to operate on, for example, power generated by a solar power generation device. According to such configuration, the work robot 10 can be operated at low costs. Also, load on environments can be decreased. In another modification, the work robot 10 may be configured to operate on power supplied from a power supply other than the solar power generation device. The power supply for the robot system 2 and the work robot 10 is not limited in particular.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A robot configured to place a workpiece on a placement section marked with a landmark, the robot comprising:
a movable arm; and
a controller configured to control the movable arm,
wherein
the movable arm comprises a gripper configured to grip the workpiece and an imaging unit configured to image the landmark marked in the placement section and the workpiece, and
the controller is configured to:
operate the movable arm to move the gripper and the imaging unit to a position near the workpiece;
recognize a position and an appearance of the workpiece based on first image information obtained by imaging the workpiece by the imaging unit;
grip the recognized workpiece by the gripper;
operate the movable arm, with the gripper gripping the workpiece, to move the gripper and the imaging unit to a position near the landmark marked in the placement section;
recognize a position of the placement section based on second image information obtained by imaging the landmark by the imaging unit; and
place the workpiece gripped by the gripper on the recognized placement section.

2. The robot according to claim 1, wherein the placement section marked with the landmark is configured movable.

3. The robot according to claim 1, wherein the robot is configured to operate on power generated by a solar power generation device.

4. The robot according to claim 2, wherein the robot is configured to operate on power generated by a solar power generation device.
